(19) United States
(12) Patent Application Publication
(10) Pub. No.: US 2011/0109857 A1
(43) Pub. Date: May 12, 2011

(54) LIQUID CRYSTAL DISPLAY DEVICE

(76) Inventors: Yasuo IMANISHI, Katano (JP); Masaki Matsumori, Naka-gun (JP); Yasushi Tomioka, Hitachinaka (JP)

(21) Appl. No.: 12/938,515

(22) Filed: Nov. 3, 2010

(30) Foreign Application Priority Data
Nov. 6, 2009 (JP) 2009-255541

(51) Int. Cl. G02F 1/1337

(52) U.S. Cl. 349/129

(57) ABSTRACT

A liquid crystal display device, comprising: a pair of substrates at least one of which is transparent; a liquid crystal layer arranged between the pair of substrates; a group of electrodes for applying an electric field to the liquid crystal layer, as formed on at least one substrate of the pair of substrates; a plurality of active elements connected to the group of electrodes; and an orientation film arranged on the pair of substrates, wherein at least one orientation film contains a polyimide having a specific chemical structure of any of an anionic organic acid except organic acids in the narrow sense, or an acid ester group of an anionic organic acid except organic acids in the narrow sense.

### CROSS-REFERENCE TO RELATED APPLICATION

The present application claims priority from Japanese application JP2009-255541 filed on Nov. 6, 2009, the content of which is hereby incorporated by reference into this application.

### BACKGROUND OF THE INVENTION

1. Field of the Invention

The present invention relates to a liquid crystal display device.

2. Description of the Related Art

Offering high display quality and having advantages of thinness, lightweightness and low power consumption, use of liquid crystal display devices is expanding for application in various fields of mobile monitors such as mobile phone monitors, digital still camera monitors, as well as desktop personal computer monitors, printing or designing monitors, medical monitors, and further liquid crystal televisions, etc.

With the expanding use applications thereof, liquid crystal display devices are required to satisfy further improved image sharpness and quality. In particular, they are earnestly required to have increased brightness and reduced power consumption through transmittance increase. In addition, with popularization thereof, there is a great demand for cost reduction of liquid crystal display devices.

In general, display on a liquid crystal display device is attained by applying an electric field to the liquid crystal molecules in the liquid crystal layer sandwiched between a pair of substrates to thereby change the direction of liquid crystal molecules' orientation and to further change the optical properties of the liquid crystal layer.

The direction of liquid crystal molecules' orientation in the absence of an electric field is controlled by the orientation film which made rubbing aliment treatment on the surface of a polyimide thin film. Heretofore, in an active drive-type liquid crystal display device equipped with a switching element such as TFT (thin-film transistor) or the like for every pixel, an electrode is arranged on each of a pair of substrates between which a liquid crystal layer is sandwiched, and the electric field to be applied to the liquid crystal layer is so designed that its direction could be substantially perpendicular to the substrate face, or that is, it could be a so-called vertical electric field, and the device of the type attains image display based on the optical rotatory characteristic of the liquid crystal molecules that constitute the liquid crystal layer.

As a typical liquid crystal display device of such a vertical field mode, known is a twisted nematic (TN) mode. Of the TN-mode liquid crystal display device, the viewing angle is narrow, which is one serious problem with the device.

As a display mode for attaining a broadened viewing angle, there are known an IPS (in-plane switching) mode and an FFS (fringe-field switching) mode.

In the IPS mode and the FFS mode, a comb-like (pectinate) electrode is formed on one of a pair of substrates, and the electric field to be generated has components substantially parallel to the substrate face, or that is, the mode is a so-called in-plane electric field display mode. In the IPS mode and the FFS mode, the liquid crystal molecules constituting the liquid crystal layer are rotated in the plane substantially parallel to the substrate, and the image display is attained based on the birefringence of the liquid crystal layer.

The IPS mode and the FFS mode have the advantages of a broader viewing angle and a lower load capacity than the conventional TN mode owing to the in-plane switching of liquid crystal molecules therein, and they are expected as a novel liquid crystal display device substitutable for the TN mode, and have made great advances recently.

In the FFS-mode liquid crystal display device, a display image burn-in phenomenon is a serious problem with the device. One reason for the display image burn-in is said to be because of the fluctuation in the micro-pixel structure composed of complicated components and in the TFT drive circuit.

As one method for overcoming the burn-in phenomenon, proposed is a method of reducing the resistance of the orientation film arranged in the liquid crystal display device. For example, JP 5-127166A discloses that a stilbene-based orientation film material is an orientation film material capable of reducing the electric resistance of the orientation film and therefore effective for preventing, impurity ion adsorption thereto, for preventing localized charge generation and for static protection in rubbing.

WO2004/053583 discloses that a low-resistance polyimide-based orientation film material having a structure linked with an amino group in the main chain backbone thereof is an orientation film material excellent in alignment control and rubbing durability, having high voltage holding and capable of reducing charge accumulation therein.

On the other hand, saying that reduction in the electric resistance of an orientation film results in increase in the polarity of the orientation film itself and therefore causes burn-in and fluctuation in the voltage holding ratio and the threshold voltage, JP 9-110981A discloses a polyimide-based orientation film material that contains a polysiloxane group in the main chain or at the end of chain thereof.

Provision of only one orientation film layer could not sufficiently solve the problem of burn-in, and JP 2008-216858A discloses a device structure with an additional thin film layer having a low electric resistance arranged as the lower layer below the orientation film material.

### SUMMARY OF THE INVENTION

An object of the invention is to provide a liquid crystal display device capable of preventing display image burn-in and having high transmittance. The above-mentioned and other objects and novel characteristic features of the invention are clarified by the description given in this specification and the drawings attached thereto.

The invention provides a liquid crystal display device includes: a pair of substrates at least one of which is transparent; a liquid crystal layer arranged between the pair of substrates; a group of electrodes for applying an electric field to the liquid crystal layer, as formed on at least one substrate of the pair of substrates; a plurality of active elements connected to the group of electrodes; and an orientation film arranged on the pair of substrates, wherein at least one orientation film contains a polyimide having a chemical structure represented by the following chemical formula (1):

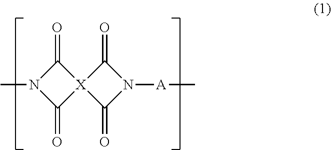

In this, X represents a tetravalent organic group, and A represents a divalent organic group. Further, A has a chemical structure D of any of an anionic organic acid except organic acids in the narrow sense, or an acid ester group of an anionic organic acid except organic acids in the narrow sense.

The invention also provides a liquid crystal display device includes: a pair of substrates at least one of which is transparent; a liquid crystal layer arranged between the pair of substrates; a group of electrodes for applying an electric field to the liquid crystal layer, as formed on at least one substrate of the pair of substrates; and a plurality of active elements connected to the group of electrodes, wherein the group of electrodes include common electrodes and pixel electrodes, an interlayer is formed on the common electrode or the pixel electrode, and an orientation film is formed on the interlayer, and wherein at least one orientation film contains a polyimide having a chemical structure represented by the following chemical formula (1):

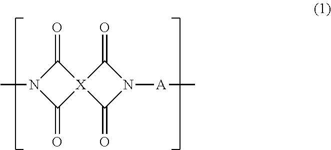

In this, X represents a tetravalent organic group, and A represent a divalent organic group. Further, A has a chemical structure D of any of an anionic organic acid except organic acids in the narrow sense, or an acid ester group of an anionic organic acid except organic acids in the narrow sense.

According to the invention, there is provided a liquid-crystal display device capable of preventing display image burn-in and having high transmittance.

### BRIEF DESCRIPTION OF THE DRAWINGS

FIG. 1A is a schematic block view showing one example of the outline structure of a liquid crystal display device of the invention.

FIG. 1B is a schematic circuit view showing one example of the circuit structure of one pixel of the liquid crystal display panel in a liquid crystal display device of the invention.

FIG. 1C is a schematic plan view showing one example of the outline structure of the liquid crystal display panel in a liquid crystal display device of the invention.

FIG. 1D is a schematic cross-sectional view showing one example of the cross section structure along the 1D-1D line in FIG. 1C.

FIG. 2 is a schematic cross-sectional view showing one example of the outline structure of an IPS-mode liquid crystal display panel in a liquid crystal display device of the invention.

FIG. 3 is a schematic cross-sectional view showing one example of the outline structure of an FFS-mode liquid crystal display panel in a liquid crystal display device of the invention.

FIG. 4 is a schematic cross-sectional view showing one example of the outline structure of a VA-mode liquid crystal display panel in a liquid crystal display device of the invention.

FIG. 5A is a schematic view showing one example of the mechanism of removal of residual charges around the orientation film in a liquid crystal display device of the invention.

FIG. 5B is an explanatory view showing one example of the concentration distribution of the chemical structure D contained in the orientation film arranged in a liquid crystal display device of the invention.

FIG. 5C is an explanatory view showing one example of the concentration distribution of the chemical structure D contained in the orientation film arranged in a liquid crystal display device of the invention.

### DETAILED DESCRIPTION OF THE INVENTION

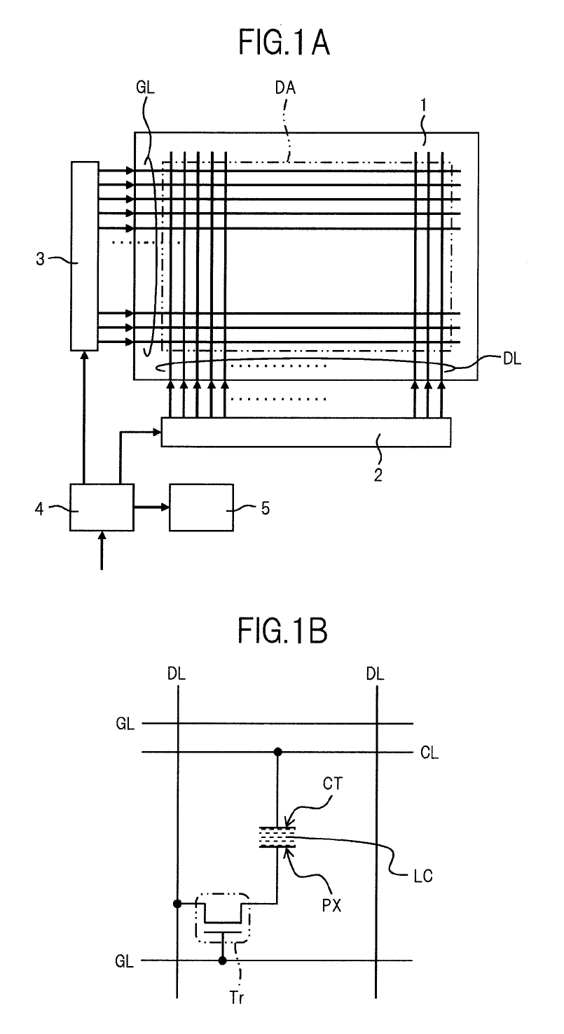

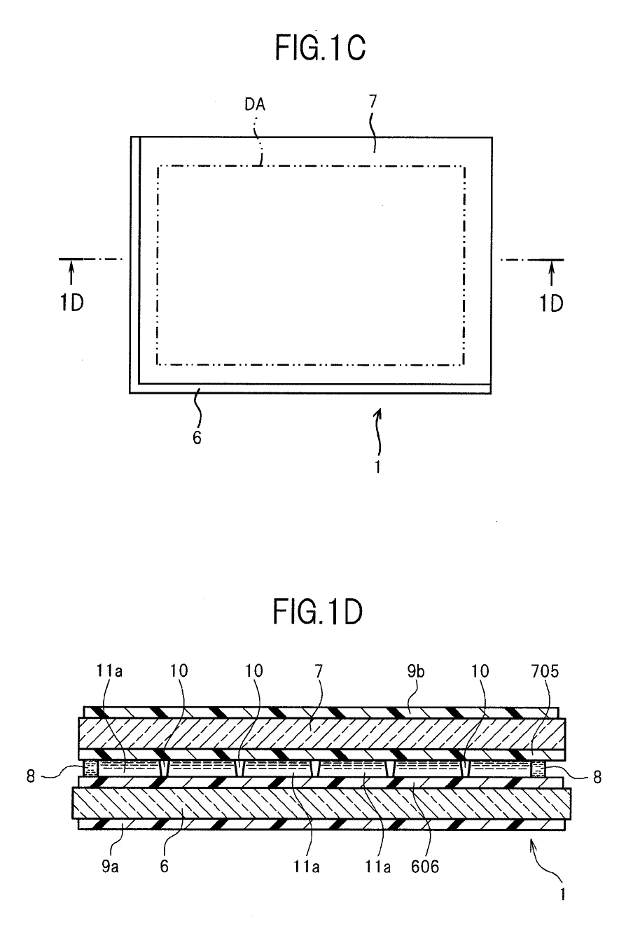

FIG. 1A to FIG. 1D are schematic views each showing one example of the outline structure of a liquid crystal display device of the invention.

FIG. 1A is a schematic block view showing one example of the outline structure of a liquid crystal display device of the invention. FIG. 1B is a schematic circuit view showing one example of the circuit structure of one pixel of the liquid crystal display panel 1. FIG. 1C is a schematic plan view showing one example of the outline structure of the liquid crystal display panel 1. FIG. 1D is a schematic cross-sectional view showing one example of the cross section structure along the 1D-1D line in FIG. 1C.

The invention is applied, for example, to an active matrix-mode liquid crystal display device. The active matrix-mode liquid crystal display device is used in displays (monitors) for mobile electronic instruments, displays for personal computers, displays for printing or designing applications, displays for medical instruments, liquid crystal televisions, etc.

The active matrix-mode liquid crystal display device comprises a liquid crystal display panel 1, a first drive circuit 2, a second drive circuit 3, a control circuit 4 and a backlight 5, for example, as shown in FIG. 1A.

The liquid crystal display panel 1 has a plurality of scanning signal lines (gate lines) GL and a plurality of video signal lines (drain lines) DL, in which the video signal lines DL are connected to the first drive circuit 2 and the scanning signal lines GL are to the second drive circuit 3.

FIG. 1A shows a part of the plurality of scanning signal lines GL, and in an actual liquid crystal display panel 1, there are densely arranged a further larger number of scanning signal lines GL.

Similarly, FIG. 1A shows a part of the plurality of video signal lines DL, and in an actual liquid crystal display panel 1, there are densely arranged a further larger number of video signal lines DL.

The display area DA of the liquid crystal display panel 1 is composed of assemblies of a large number of pixels; and the region that one pixel occupies in the display area DA corresponds to, for example, the region surrounded by two neighboring scanning signal lines GL and two neighboring video signal lines DL.

In this, the circuit constitution of one pixel is, for example, the constitution as shown by FIG. 1B, comprising a TFT (thin-film transistor) element Tr functioning as an active element, a pixel electrode PX, a common electrode CT (this may be referred to as a counter electrode), and a liquid crystal layer 11a.

In this, the liquid crystal display panel 1 is provided with, for example, a common line CL that shares the common electrode CT of plural pixels.

The liquid crystal display panel 1 is so designed that orientation films 606 and 705 are formed on the surface of the active matrix substrate 6 and that of the counter substrate 7 therein and a liquid crystal layer 11a (liquid crystal material) is arranged between the orientation films, for example, as shown in FIG. 1C and FIG. 1D.

Though not specifically shown, an interlayer (for example, a retardation plate or an optical interlayer such as a color conversion layer, a light diffusion layer or the like) may be suitably arranged between the orientation film 606 and the active matrix substrate 6, or between the orientation film 705 and the counter substrate 7.

In this case, the active matrix substrate 6 and the counter substrate 7 are bonded with the circular sealant 8 arranged outside the display area DA, and the liquid crystal layer 11a is sealed up in the space surrounded by the orientation film 606 on the side of the active matrix substrate 6, the orientation film 705 on the side of the counter substrate 7 and the sealant 8.

In this case, the liquid crystal display panel 1 of the liquid crystal display device having the backlight 5 has a pair of polarizers 9a and 9b as arranged to face each other via the active matrix substrate 6, the liquid crystal layer 11a and the counter substrate 7 sandwiched therebetween.

The active matrix substrate 6 comprises a scanning signal line GL, a video signal line DL, an active element (TFT element Tr), a pixel electrode PX and others arranged on an insulation substrate such as a glass substrate 601.

In case where the drive mode of the liquid crystal display panel 1 is a horizontal field drive mode such as an IPS (in-plane switching) mode or the like, the common electrode CT and the common line CL are arranged on the active matrix substrate 6.

In case where the drive mode of the liquid crystal display panel 1 is a vertical field drive mode such as a TN (twisted nematic) mode or a VA (vertically alignment) mode, the common electrode CT is arranged on the counter substrate 7.

In the vertical field drive mode liquid crystal display panel 1, in general, the common electrode CT is one large-area tabular electrode that is shared by all the pixels therein, and the common line CL is not arranged.

The liquid crystal display device of the invention is provided with, for example, a plurality of columnar spacers 10 for equalizing the thickness (this may be referred to as a cell gap) of the liquid crystal layer 11a in every pixel, in the space in which the liquid crystal layer 11a is sealed up. The plurality of columnar spacers 10 are, for example, arranged on the counter substrate 7.

The first drive circuit 2 is a drive circuit to form a video signal (this may be referred to as a gradation voltage) that is to be given to the pixel electrode PX of each pixel via the video signal line DL, and is a drive circuit generally referred to as a source driver, a data driver or the like.

The second drive circuit 3 is a drive circuit to form a scanning signal that is to be given to the scanning signal line GL, and is a drive circuit generally referred to as a gate driver, a scanning driver or the like.

The control circuit 4 is a circuit to control the performance of the first drive circuit 2, to control the performance of the second drive circuit 3 and to control the brightness of the backlight 5, and is a control circuit generally referred to as a TFT controller, a timing controller or the like.

The backlight 5 is, for example, a fluorescent lamp such as a cold cathode fluorescent lamp, or a light source such as a light emitting diode (LED) or the like; and the light emitted by the backlight 5 is converted into a tabular ray by a reflector, a waveguide, a light diffuser, a prism sheet or the like, and is radiated to the liquid crystal display panel 1.

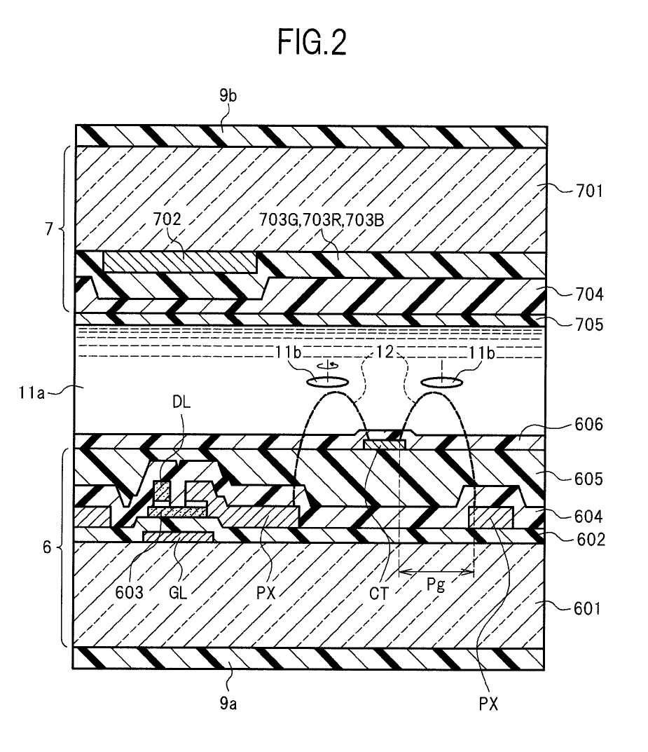

FIG. 2 is a schematic cross-sectional view showing one example of the outline structure of an IPS-mode liquid crystal display panel 1 in the invention. The active matrix substrate 6 comprises a scanning signal line GL and a common line CL, and a first insulation layer 602 to cover them, as formed on the surface of an insulation substrate such as a glass substrate 601.

On the first insulation layer 602, formed are a semiconductor layer 603 of a TFT element Tr, a video signal line DL and a pixel electrode PX, and a second insulation layer 604 to cover them. The semiconductor layer 603 is arranged above the scanning signal line GL; and the part of the scanning signal line GL that is positioned below the semiconductor layer 603 functions as the gate electrode of the TFT element Tr.

The semiconductor layer 603 comprises, for example, as laminated on an active layer (channel forming layer) of a first amorphous silicon, a source diffusion layer and a drain diffusion layer of a second amorphous silicon differing from the first amorphous silicon in point of the type and the concentration of the impurity therein.

In this, a part of the video signal line DL and a part of the pixel electrode PX individually run on the semiconductor layer 603, and the parts thereof on the semiconductor layer 603 function as the drain electrode and the source electrode of the TFT element Tr.

The source and the drain of the TFT element Tr replace each other depending on the bias relation, or that is, the relation of the potential level between the pixel electrode PX and the video signal line DL when the TFT element Tr is turned ON.

However, in the following description in this specification, the electrode connected to the video signal line DL is referred to as a drain electrode, while the electrode connected to the pixel electrode is referred to as a source electrode 607. On the second insulation layer 604, formed is a third insulation layer 605 (overcoat layer) of which the surface is flattened.

On the third insulation layer 605, formed are a common electrode CT, and an orientation film 606 to cover the common electrode CT and the third insulation layer 605. The common electrode CT is connected to the common line CL via the contact hole CH (through-hole) running through the first insulation layer 602, the second insulation layer 604 and the third insulation layer 605.

The common electrode CT is, for example, so designed as to be spaced by an in-plane distance Pg of 7 μm or so from the pixel electrode PX.

The orientation film 606 is formed by coating with the polymer material described in Examples given hereinunder, and is surface-treated (by rubbing alignment treatment or the like) for imparting the liquid crystal alignment capability to the surface thereof.

On the other hand, the counter substrate 7 comprises, as formed on the surface of an insulation substrate of a glass substrate 701 or the like, a black matrix 702 and a color filter 703R, 703G or 703B, and an overcoat layer 704 to cover these.

The black matrix 702 is a lattice-like light-shielding film for providing a pixel-unit open region in the display region DA.

The color filter 703R, 703G or 703B is, for example, a film that transmits only a light falling within a specific wavelength region (color) of the white light from the backlight 5, and in case where the liquid crystal display device corresponds to RGB-mode color display, a color filter 703R capable of transmitting a red light, a color filter 703G capable of transmitting a green light, and a color filter 703B capable of transmitting a blue light are arranged therein (in this, one typical color pixel is illustrated.)

The surface of the overcoat layer 704 is flattened. On the overcoat layer 704, formed are a plurality of columnar spacers 10 and an orientation film 705.

The columnar spacer 10 is, for example, a circular truncated cone (this may be referred to as a trapezoidal rotator) of which the top is flattened, and is formed at the position at which it overlaps with the part except the part where the TFT element Tr is arranged and except the part at which it crosses the video signal line DL, among the scanning signal lines GL of the active matrix substrate 6.

The orientation film 705 is, for example, formed of a polyimide resin, and is surface-treated (by rubbing alignment treatment or the like) for imparting the liquid crystal alignment capability to the surface thereof.

The liquid crystal molecules 11b in the liquid crystal layer 11a in the liquid crystal display panel 1 of the mode of FIG. 2 are aligned substantially horizontally to the surfaces of the glass substrates 601 and 701 in the absence of an electric field in which the potential of the pixel electrode PX is equal to that of the common electrode CT, and are homogeneously aligned in the original alignment direction thereof as controlled by the rubbing alignment treatment given to the orientation films 606 and 705.

When the TFT element Tr is turned ON and the gradation voltage given to the video signal line DL is written in the pixel electrode PX thereby producing a potential difference between the pixel electrode PX and the common electrode CT, then an electric field (line of electric force) 12 is generated as shown in the drawing, and the electric field 12 having the intensity corresponding to the potential difference between the pixel electrode PX and the common electrode CT is thereby imparted to the liquid crystal molecule 11b.

In this case, owing to the interaction between the dielectric anisotropy of the liquid crystal layer 11a and the electric field 12, the liquid crystal molecules 11b constituting the liquid crystal layer 11a are aligned in the direction of the electric field 12, and therefore the refractive anisotropy of the liquid crystal layer 11a thereby changes.

In this case, the direction of the liquid crystal molecule 11b is determined by the intensity of the electric field 12 (the potential difference between the pixel electrode PX and the common electrode CT) applied thereto.

Accordingly, in the liquid crystal display device, for example, the potential of the common electrode CT is kept fixed and the gradation voltage to be applied to the pixel electrode PX is controlled for every pixel so as to change the light transmittance through the pixel, thereby realizing moving picture or image display on the device.

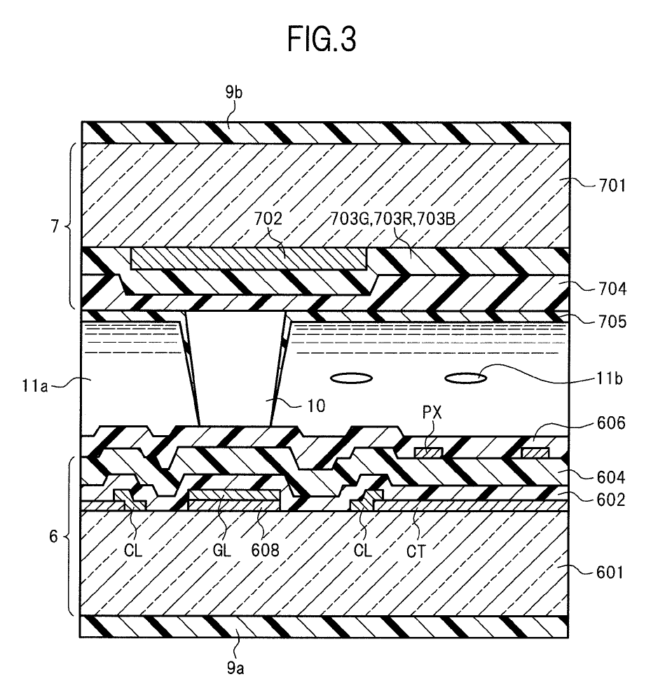

FIG. 3 is a schematic cross-sectional view showing one example of the outline structure of an FFS (fringe field switching)-mode liquid crystal display panel 1 in the invention.

The active matrix substrate 6 comprises a common electrode CT, a scanning signal line GL and a common line CL, and a first insulation layer 602 to cover them, as formed on the surface of an insulation substrate such as a glass substrate 601. Below the scanning signal line GL, provided is a conductive layer 608.

On the first insulation layer 602, formed are a semiconductor layer 603 of a TFT element Tr, a video signal line DL and a source electrode 607, and a second insulation layer 604 to cover them.

In this, a part of the video signal line DL and a part of the source electrode 607 individually run on the semiconductor layer 603, and the parts thereof on the semiconductor layer 603 function as the drain electrode and the source electrode of the TFT element Tr.

In the liquid crystal display panel 1 of FIG. 3, a third insulation layer 605 is not formed, but on the second insulation layer 604, formed are a pixel electrode PX and an orientation film 606 to cover the pixel electrode PX.

The pixel electrode PX is connected to the source electrode 607 via the contact hole CH (through-hole) running through the second insulation layer 604.

In this case, the common electrode CT formed on the surface of the glass substrate 601 is formed like a plate in the region surrounded by two neighboring scanning signal lines GL and two neighboring video signal lines DL (opening region), and a pixel electrode PX having plural slits is laminated on the tabular common electrode CT.

In this case, the common electrode CT for pixel aligned in the extending direction from the scanning signal line GL is shared by the common line CL.

On the other hand, the counter substrate 7 in the liquid crystal display panel 1 of FIG. 3 has the same constitution as that of the counter substrate 7 in the liquid crystal display panel 1 of FIG. 2. Therefore, the detailed description of the constitution of the counter substrate 7 is omitted here.

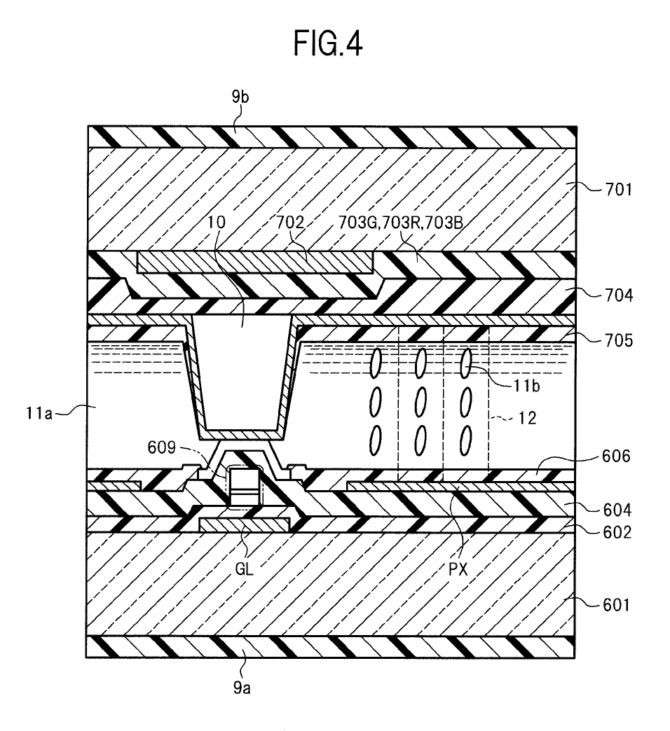

FIG. 4 is a schematic cross-sectional view showing one example of the cross-sectional structure of the main part of a VA-mode liquid crystal display panel 1 in the invention.

The vertical field drive-mode liquid crystal panel 1 comprises, for example, as shown in FIG. 4, a pixel electrode PX formed on the active matrix substrate 6, and a common electrode CT formed on the counter electrode 7.

In the case of the VA-mode liquid crystal display panel 1, a type of the vertical field drive mode, the pixel electrode PX and the common electrode CT are, for example, formed of a transparent conductor such as ITO as a solid plate (simple tabular form).

Above the scanning signal line GL, provided is a projection-forming component 609 via a first insulation layer 602 arranged therebetween. The projection-forming component includes a semiconductor layer and a conductor layer.

In this case, the liquid crystal molecules 11b are aligned vertically to the surfaces of the glass substrates 601 and 701 by the orientation films 606 and 705 in the absence of an electric field in which the potential of the pixel electrode PX is equal to that of the common electrode CT. When there occurs a potential difference between the pixel electrode PX and the common electrode CT, then an electric field (line of electric force) 12 is generated substantially perpendicularly to the glass substrates 601 and 701, whereupon the liquid crystal molecules 11 are laid down in the direction parallel to the substrates 601 and 701 and the polarization condition of the incoming light thereby changes.

In this case, the direction of the liquid crystal molecules 11b is determined by the intensity of the electric field 12 applied to the device. Accordingly, in the liquid crystal display device, for example, the potential of the common electrode CT is kept fixed and the video signal (gradation voltage) to be applied to the pixel electrode PX is controlled for every pixel so as to change the light transmittance through the pixel, thereby realizing moving picture or image display on the device.

Various constitutions of the pixel in the VA-mode liquid crystal display panel 1, for example, various constitutions of the tabular configuration of the TFT element Tr and the pixel electrode PX are known; and the pixel constitution in the liquid crystal display panel 1 of the mode of FIG. 4 may be any of such known constitutions.

In the present specification, the detailed description of the pixel of the liquid crystal display panel 1 is omitted.

The invention relates to the constitution of the liquid crystal display panel 1 of the above-mentioned active matrix-mode liquid crystal display device, especially to the constitution of the part contacting the liquid crystal layer 11a in the active matrix substrate 6 and the counter substrate 7 and the constitution around it in the device.

Accordingly, the detailed description of the constitution of the first drive circuit 2, the second drive circuit 3, the control circuit 4 and the backlight 5 that are not in direct relation to the invention is omitted here.

As shown in FIG. 1B, in the liquid crystal display device, the TFT element Tr is turned ON in case where a voltage is applied to the scanning signal line GL, and in that condition, the voltage applied to the video signal line DL is imparted to the pixel electrode PX via the TFT element Tr, whereupon the potential difference generated between the pixel electrode PX and the common electrode CT is imparted to the liquid crystal layer 11a as a drive electrode thereto. The voltage applied to the liquid crystal layer 11a is kept as such owing to the capacitance of the liquid crystal layer 11a, even when the TFT element Tr is turned OFF.

The voltage to be applied to the liquid crystal layer 11a is an alternating-current voltage; however, in actual driving, a slight direct-current voltage may be superposed thereon. The direct-current voltage component is accumulated in the interface between the liquid crystal layer 11a and the orientation film 606 on the side of the active matrix substrate 6 (residual charge). The degree of accumulation of the direct current component differs in every gradation, therefore causing display image burn-in.

The burn-in is more remarkable when the resistivity (the specific resistance value) of the orientation film is higher, and in particular, when the resistivity thereof is more than 10¹⁴ Ωcm, it is extremely remarkable.

Patent Reference 4 proposes, between an orientation film and an insulation film, arrangement of a charge emission film having a lower resistance than the orientation film. However, this describes nothing about transmittance.

When an additional film is arranged, the transmittance reduction is inevitable; but Patent Reference 4 describes nothing about the transmittance of the charge emission layer. When the transmittance of a liquid crystal display panel lowers, then the liquid crystal display device may have some problems of brightness reduction and consuming power increase.

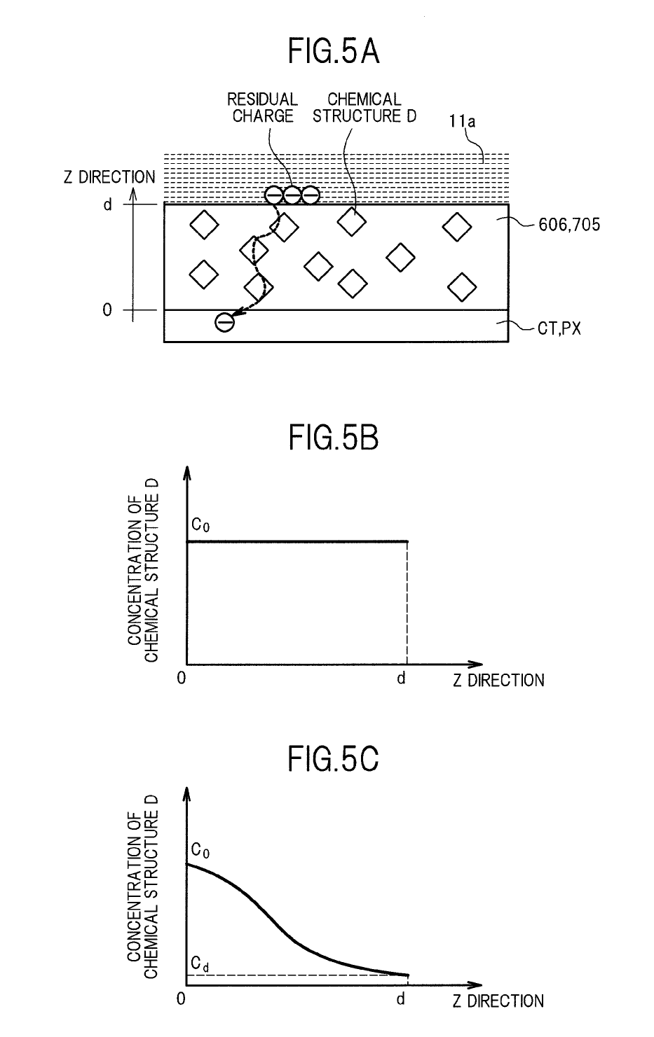

FIG. 5A schematically shows the structure around the orientation film of the liquid crystal display device having an orientation film of the invention that is suitable for solving the problems. The orientation film 606 (or 705) is in contact with the liquid crystal layer 11a, and residual charges form in the interface therebetween.

The residual charges must be effective removed through the common electrode CT (or the pixel electrode PX) via the orientation film 606 (or 705).

For effectively removing the residual charges, for example, the orientation film 606 (or 705) arranged in the liquid crystal display device must satisfy the following characteristic features:

1) The film has a suitable resistivity (smaller than the resistivity 10¹⁴ Ωcm of existing orientation films).

2) The film does not detract from transparency (in the liquid crystal display device, the transmittance of the orientation film alone at a wavelength of from 380 to 750 nm is at least 90%, more preferably at least 95%).

3) The film has a suitable specific dielectric constant (for example, the specific dielectric constant ∈ is preferably at least 20 in order that the organic thin film could have a sufficient ionic conductivity; however, since the refractive index √∈ is around 4.47 and since the refractive index of the glass substrates 601 and 701 and the liquid crystal layer 11a that are the other members of the liquid crystal display device is from 1.4 to 2.1 or so, such a high specific dielectric constant of the film may bring about increase in the reflectivity derived from the refractivity difference at the interface).

In the invention, the orientation film containing a polyimide that has a chemical structure suitable to the above 1) to 3) is described concretely hereinunder.

In this description, the chemical structure suitable to the above 1) to 3) is specifically referred to as a chemical structure D.

The present inventors have found that the chemical structure D is an anionic organic acid except organic acids in the narrow sense, or an acid ester group of an anionic organic acid except organic acids in the narrow sense.

In addition to the above-mentioned 1) to 3), 4) the orientation film must have a inner molecular structure that hardly generates residual charges by itself. This is because the easy removal of charges from the surface of the orientation film exactly means that the film is readily influenced by any slight fluctuation of the external electric field applied thereto therefore providing the risk of charge injection thereinto via the impurities inside the liquid crystal layer 11a.

Regarding the molecular structure inside the orientation film, the mean concentration distribution of the chemical structure D in the orientation film in the thickness direction (in the z-direction shown in FIG. 5A) of the film could be a constant concentration C₀ in every position in the z-direction, for example, as shown in FIG. 5B. Depending on the composition of the orientation film and the film formation condition, the molecular structure concentration may have a gently-changing profile inside the film in such a manner that the concentration is the highest, C₀ at z=0 and the concentration gradually lowers in the thickness direction to be C_{d} at z=d, for example, as shown in FIG. 5C.

For satisfying the condition of the above 4), preferably, the orientation film has a profile of the molecular structure concentration inside it, as in FIG. 5C.

Specifically, it is desirable that the molecular structure inside the orientation film differs between the surface of the film on the liquid crystal side and the other surface thereof opposite to the liquid crystal side.

Preferably, the conductivity of the orientation film differs between the surface of the film on the liquid crystal side and the other surface thereof opposite to the liquid crystal side, and it is desirable that the conductivity of the surface of the orientation film on the liquid crystal side is lower than the conductivity of the other surface thereof opposite to the liquid crystal side.

Further, regarding the conductivity distribution in the orientation film, it is desirable that the conductivity of the surface of the orientation film on the liquid crystal side is the lowest and the conductivity of the other surface thereof opposite to the liquid crystal side is the highest.

Also preferably, the conductivity of the orientation film increases from the surface of the film on the liquid crystal side toward the other surface thereof opposite to the liquid crystal side.

The chemical structure D satisfying the above-mentioned conditions 1) to 3) must satisfy the characteristics of anchoring energy for liquid crystal molecules, stability in long-term driving operation, transparency and the like of the orientation film for use in a liquid crystal display device, which already-existing orientation films have, and must satisfy other characteristics in that it can remove residual charges from the surface of the orientation film that may cause the residual image in a liquid crystal display device and can protect the film from generation of residual charges thereon.

For making the orientation film satisfy the above-mentioned characteristics, the structure of the film is desired to be specifically so planned as to have an increased conductivity. However, since the orientation film of a liquid crystal display device is an organic polymer material of mainly a polyimide, and almost all organic materials are insulators.

One typical method for increasing the conductivity of an organic material itself comprises introducing an electron-conjugated system structure into the main chain of a polymer, for example, as in polyacetylene, polydiacetylene, polythiophene, etc. Another method comprises forming a molecular pair of an electron-donating structure and an electron-accepting structure inside the molecule to thereby realize high conductivity, for example, as in bis(ethylene-dithiolo)tetrathiofulvalene (BEDT-TTF) and tetracyanoquinodimethane (TCNQ) organic molecule complex.

In these, however, an electron-conjugated state such as metal is formed in an organic material and is therefore accompanied by transparency reduction owing to electron absorption. Specifically, introduction of the above-mentioned compound into an orientation film may cause reduction in the transmittance of the orientation film itself.

Another method known for increasing the conductivity of an organic material itself to form an orientation film comprises introducing into the orientation film an ionic polymer having polyethylene as the typical polymer main chain thereof and containing an organic salt in the side chain, such as polyacrylic acid salt, polysulfonic acid salt, polyammonium salt or the like.

The ionic polymer having an organic salt in the side chain thereof is excellent in transparency since it does not have an electronic conjugated structure spreading entirely inside the polymer molecule. Specifically, when such an ionic polymer having an organic salt in the side chain thereof is introduced into an orientation film, the reduction in the transparency of the film is relatively small.

However, the ionic polymer having an organic slat in the side chain thereof is a polar polymer, and is therefore poorly compatibility with a non-polar polymer such as a polyimide or the like that is a typical material for an orientation film, and has a poor affinity to liquid crystal molecules for a display material that is a non-polar low-molecular organic material.

In addition, the impurities contained in the ionic polymer having an organic salt in the side chain thereof may be electrophoresed by residual charges, thereby causing additional display unevenness.

For increasing conductivity in some degree though the resulting conductivity level may be lower than that to be attained by the use of the ionic polymer having an organic salt in the side chain or the like, for example, there is known a method of hopping conduction with charges in which polyethylene having a conjugated molecular structure with a nitrogen atom N as a hetero atom, such as polyvinyl carbazole (PVCz) in the side chain thereof is used and the electrically nonionic N atom in the conjugated molecular structure is temporarily converted into a cationic state, N⁺ state.

For effective hopping of such a temporary nonionic/cationic state, the hetero-conjugated molecular structure must be dispersed in a relatively high density. In addition, an electrode material that enables first charge injection into a basically non-ionic organic material is necessary.

The hetero nitrogen atom tends to be thermally degraded by heating in air and causes discoloration. For example, Patent Reference 2 proposes a structure of introducing such a hetero nitrogen atom into the main chain conjugated skeleton of a polyimide, in which, however, the recurring unit of the polymer is long and the polymer could hardly realize hopping conduction and produces discoloration through thermal degradation.

From the already-existing knowledge relating to the conductivity of these organic materials, the present inventors have found a structure capable of imparting a suitable conductivity to the orientation film of a liquid crystal display device not detracting from the other properties of the film.

The liquid crystal display device of the invention comprises a pair of substrates at least one of which is transparent; a liquid crystal layer arranged between the pair of substrates; a group of electrodes for applying an electric field to the liquid crystal layer, as formed on at least one substrate of the pair of substrates; a plurality of active elements connected to the group of electrodes; and an orientation film arranged on the pair of substrates, wherein at least one orientation film contains a polyimide having a chemical structure represented by the following chemical formula (1):

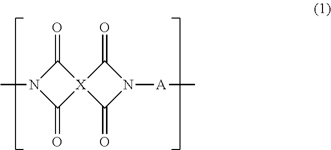

In this, X represents a tetravalent organic group, and A represent a divalent organic group. Further, A has a chemical structure D of any of an anionic organic acid except organic acids in the narrow sense, or an acid ester group of an anionic organic acid except organic acids in the narrow sense.

Specifically, X represents a tetravalent organic group, and A represent a divalent organic group. Further, A has a chemical structure D, and the chemical structure D is an anionic organic acid except organic acids in the narrow sense, or an acid ester group of an anionic organic acid except organic acids in the narrow sense.

The chemical structure D is, as so described in the above, a chemical structure satisfying the above-mentioned characteristic features 1) to 3) that are necessary for effective removal of residual charges.

Specifically, the orientation film that contains a polyimide having the chemical structure of the above-mentioned chemical formula (1) is effective for providing a liquid crystal display device free from the problem of display image burn-in and having a high transmittance.

Organic acids in the narrow sense as referred to herein include organic acids of carboxylic acids (with a carboxyl group). For example, they include formic acid, HCOOH, acetic acid CH₃COOH, etc.

Organic acids excepts organic acids in the narrow sense include organic acids with a group of phosphoric acid, sulfonic acid, etc.

Specifically, A has a chemical structure D, and the chemical structure D is an anionic organic acid that is an organic acid except carboxylic acids, or an acid ester group of an anionic organic acid that is an organic acid except carboxylic acids.

The chemical structure D in the chemical formula (1) is preferably a sulfonic acid group, a sulfonate ester group, a phosphoric acid group, or a phosphoester group.

The liquid crystal display device of the invention is also favorably used as an IPS-mode liquid crystal display device.

Specifically, the liquid-crystal display device of the invention comprises a pair of substrates at least one of which is transparent; a liquid crystal layer arranged between the pair of substrates; a group of electrodes for applying an electric field to the liquid crystal layer, as formed on at least one substrate of the pair of substrates; and a plurality of active elements connected to the group of electrodes, wherein the group of electrodes include common electrodes and pixel electrodes, an interlayer is formed on the common electrode or the pixel electrode, and an orientation film is formed on the interlayer, and wherein at least one orientation film contains a polyimide having a chemical structure represented by the following chemical formula (1):

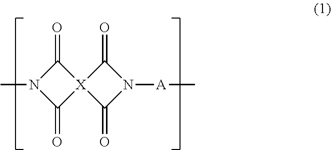

In this, X represents a tetravalent organic group, and A represent a divalent organic group. Further, A has a chemical structure D of any of an anionic organic acid except organic acids in the narrow sense, or an acid ester group of an anionic organic acid except organic acids in the narrow sense.

Specifically, X represents a tetravalent organic group, and A represent a divalent organic group. Further, A has a chemical structure D, and the chemical structure D is an anionic organic acid except organic acids in the narrow sense, or an acid ester group of an anionic organic acid except organic acids in the narrow sense.

A has a chemical structure D, and the chemical structure D is an anionic organic acid that is an organic acid except carboxylic acids, or an acid ester group of an anionic organic acid that is an organic acid except carboxylic acids.

The chemical structure D in the chemical formula (1) is preferably a sulfonic acid group, a sulfonate ester group, a phosphoric acid group, or a phosphoester group.

Preferably, the orientation film arranged in the IPS-mode liquid crystal display device is thicker than the common electrode or the pixel electrode, and additionally serves as a planarizing film for the common electrode or the pixel electrode. The orientation film for use in the liquid crystal display device of the invention may contain a polyamide acid polymer as a precursor of polyimide. The organic acid is, when intentionally anionized through alkali treatment or the like, to be a type of an ionic polymer, which, however, brings about the above-mentioned problem in that the impurities contained in the ionic polymer are electrophoresed by residual charges to cause additional display unevenness.

These organic acids are generally in a non-ionic state and do not exhibit conductivity. However, through investigations, the present inventors have found that some organic acids are locally dissociated by the residual moisture contained in the production process for ordinary liquid crystal display devices to thereby generate ionicity only partially.

Though the conductivity mechanism could not be clarified completely, local ionic protons may be electrophoresed in a space having a certain size. Accordingly, it may be considered that the local ionic proton could secure conduction hopping in a range broader than the molecular skeleton thereof, differing from the hopping conduction derived from the cationic state as trapped in a specific molecular structure such as the above-mentioned, hetero nitrogen atom-having conjugated molecular structure.

In fact, as a result of investigation of various organic acids, organic acids having a smaller acid dissociation constant pKa except organic acids in the narrow sense were found more suitable as substituents to be introduced, than organic acids having the narrow sense and having a large pKa. Specifically, it may be considered that organic acids in the narrow sense having a large acid dissociation constant pKa could not bring about local acid dissociation under the production process condition for ordinary liquid crystal display devices, and therefore could not generate conductivity. The anionic functional group having a small acid dissociation constant pKa that may provide such organic acids except organic acids in the narrow sense is preferably a proton-dissociable anionic functional group such as a phosphoric acid group —OPO₂ (OH), a sulfonic acid group —OSO₂(OH), etc. More preferred is a sulfonic acid group —OSO₂(OH) of which the acid dissociation constant pKa is smaller.

In case where the anionic functional group in such an organic acid except organic acids in the narrow sense is in direct chemical bond to a conjugated molecular skeleton, then it serves as an electron-attracting group and, as the case may be, it may cause light absorption through intramolecular charge movement.

In such a case, preferably, the anionic functional group is in chemical bond to the conjugated molecular skeleton via a non-conjugated chemical structure that cuts the conjugated system.

Specifically, in the liquid crystal display device of the invention, the chemical structure D in the chemical formula (1) contained in the orientation film is preferably in direct chemical bond to a non-conjugated organic group.

The non-conjugated organic group to which the chemical structure D in the chemical formula (1) is in direct contact includes, for example, an alkylene group (—CₙH₂ₙ—), an alkoxy group (—OCₙH₂ₙ—), etc.

Preferably, the chemical structure D in the chemical formula (1) is in direct chemical bond to the alkylene group (—CₙH₂ₙ—) having at most 11 carbon atoms or the alkoxy group (—OCₙH₂ₙ—) having at most 11 carbon atoms.

More preferably, the chemical structure D in the chemical formula (1) is in direct chemical bond to the alkylene group (—CₙH₂ₙ—) having at most 4 carbon atoms or the alkoxy group (—OCₙH₂ₙ—) having at most 4 carbon atoms.

Even more preferably, the chemical structure D in the chemical formula (1) is in direct chemical bond to the alkylene group (—CₙH₂ₙ—) having at most 2 carbon atoms or the alkoxy group (—OCₙH₂ₙ—) having at most 2 carbon atoms.

The chemical structure D in the chemical formula (1) may be in direct chemical bond to an alkylene group (—CₙH₂ₙ—).

In this case, preferably, the chemical structure D in the chemical formula (1) is in direct chemical bond to the alkylene group (—CₙH₂ₙ—) having at most 11 carbon atoms; more preferably, the chemical structure D in the chemical formula (1) is in direct chemical bond to the alkylene group (—CₙH₂ₙ—) having at most 4 carbon atoms; and even more preferably, the chemical structure D in the chemical formula (1) is in direct chemical bond to the alkylene group (—CₙH₂ₙ—) having at most 2 carbon atoms.

The chemical structure D in the chemical formula (1) may be in direct chemical bond to an alkoxy group (—OCₙH₂ₙ—).

In this case, preferably, the chemical structure D in the chemical formula (1) is in direct chemical bond to the alkoxy group (—OCₙH₂ₙ—) having at most 11 carbon atoms; more preferably, the chemical structure D in the chemical formula (1) is in direct chemical bond to the alkoxy group (—OCₙH₂ₙ—) having at most 4 carbon atoms; and even more preferably, the chemical structure D in the chemical formula (1) is indirect chemical bond to the alkoxy group (—OCₙH₂ₙ—) having at most 2 carbon atoms.

Also preferably, of the chemical structure D in the chemical formula (1), the anionic functional group is in chemical bond to the conjugated molecular skeleton via a non-conjugated chemical structure capable of cutting the conjugated system thereof, for example, via a methylene group (—CH₂—), an ethylene group (—C₂H₄—) or a methoxy group (—OCH₂—).

A mixture of a polyimide containing such an organic acid except organic acids in the narrow sense and a different polymer may also be used for the orientation film.

Specifically, the orientation film in the liquid crystal display device of the invention may be formed of a mixture of a polyimide containing the chemical structure D in the chemical formula (1) and a different polymer not containing the chemical structure D in the chemical formula (1).

For the different polymer, preferred is any one having the properties of high transmittance (little absorption of visible light), heat resistance, high film strength and capability of aligning liquid crystal molecules (hereinafter this may be referred to as the liquid crystal alignment capability).

For example, the orientation film in the liquid crystal display device of the invention may be formed of a mixture of a polyimide containing the chemical structure D in the chemical formula (1), and a polyimide not containing the chemical structure D in the chemical formula (1) and/or a polyamide acid.

The orientation film in the liquid crystal display device of the invention may be formed of a mixture of a polyimide containing the chemical structure D in the chemical formula (1) and a polyamide acid ester not containing the chemical structure D in the chemical formula (1).

Preferably, the orientation film in the liquid crystal display device of the invention is formed of a mixture of a polyimide containing the chemical structure D in the chemical formula (1) and a different polymer not containing the chemical structure D in the chemical formula (1), wherein the blend ratio of the polyimide containing the chemical structure D in the chemical formula (1) to the different polymer not containing the chemical structure D in the chemical formula (1) (polyimide containing the chemical structure D/different polymer not containing the chemical structure D) is from 1/9 to 3/1.

Also preferably, the orientation film in the liquid crystal display device of the invention is formed of a mixture of a polyimide containing the chemical structure D in the chemical formula (1) and a different polyimide not containing the chemical structure D in the chemical formula (1), wherein the blend ratio of the polyimide containing the chemical structure D in the chemical formula (1) to the different polyimide not containing the chemical structure D in the chemical formula (1) (polyimide containing the chemical structure D/different polyimide not containing the chemical structure D) is from 1/9 to 3/1.

In particular, when the orientation film is formed of a combination of plural polymers, the mixture could be a uniform polymer solution before coating but it could provide a desired concentration distribution of the organic acid, for example, as in FIG. 5C, through spontaneous phase separation or self-organization in the process of coating and drying, owing to the polarity difference between the polymers.

For example, in case where an orientation film is formed of a blend of a polyimide having high conductivity and a non-conductive (high-alignment) polyimide, a gentle distribution of the chemical structure D in the chemical formula (1) can be formed from the side of the glass substrate toward the surface of the orientation film.

Further, when pores having a smaller mean pore size (diameter) than the wavelength of visible light are formed inside the orientation film, then the specific dielectric constant of the orientation film may be lowered with no light scattering therein, and therefore residual charges themselves owing to the driving fluctuation in the TFT circuit in the liquid crystal display device could be hardly accumulated on the surface of the orientation film.

In this case, for completely preventing light scattering therein, the orientation film contains pores having a mean pore size of at most 100 nm and is formed of a material to give the film having a specific dielectric constant of at most 2.0.

Preferably, the orientation film in the liquid crystal display device of the invention contains pores having a mean pore size of at most 100 nm and is formed of a material to give the film having a specific dielectric constant of at most 2.0.

In case where the orientation film in the liquid crystal display device of the invention contains pores having a mean pore size of at most 100 nm and the orientation film has a specific dielectric constant of at most 2.0, the liquid crystal display device may be free from a problem of display image burn-in and may has a high transmittance.

In case where the orientation film has a specific chemical structure concentration distribution and a pore structure inside the film, for example, the film could be insufficiently characterized by the resistivity of the entire film. For example, even though a low-resistance polyimide could have a resistivity of 10¹² Ωcm as a whole of the film thereof on average, the film may have a far smaller resistivity than that level in some part thereof where current may flow in microscopic observation.

For producing the polyimide having the characteristic features as above or for producing the polyamide acid or polyamide acid ester before imidization, an ordinary method of producing ordinary aromatic polyimides may be employed. For example, pyromellitic acid dianhydride and p-phenylenediamine may be reacted in an organic solvent to produce it.

Of those, when a precursor prior to imidization of a polyamide acid ester is used, it is advantageous in that the reverse process opposite to the imidization may be retarded.

Alternatively, a polyamide acid or a polyamide acid ester is produced while the part of the sulfonic acid group is esterified to give a precursor having a sufficiently high molecular weight, and then the precursor is processed for ester dissociation and then imidized, or is imidized and then processed for ester dissociation, and this method may be effective for producing a polyimide having a large molecular weight.

In particular, a polyimide having a sulfonic acid group may be produced with reference to the method described in Technical Reference 1 mentioned below.
Technical Reference 1: Y. Yin, Y. Suto, T. Sakabe, S. Chen, S. Hayashi, T. Mishima, O. Yamada, K. Tanaka, H. Kita, and K. Okamoto: Water stability of sulfonated polyimide membranes: Macromol. 39 (2006) 1189-1198.

The orientation film in the liquid crystal display device of the invention may contain a polyimide produced from a precursor, polyamide acid ester.

The polyamide acid ester may be produced, for example, by reacting a diesterdicarboxylic acid, which is prepared by reacting a tetracarboxylic acid dianhydride such as the above-mentioned pyromellitic acid dianhydride or the like with an alcohol, with a chlorination reagent such as thionyl chloride or the like to give a diesterdicarboxylic acid chloride, followed by reacting it for polycondensation with a diamine such as the above-mentioned p-phenylenediamine or the like.

For forming the polyimide-containing orientation film in the invention in various substrates by coating, ordinary polyimide orientation film formation methods may be employed.

For example, a solution prepared by dissolving at least one of a polyimide resin, a polyamide acid of a polyimide precursor, a polyamide acid ester of a polyimide precursor and the like in a predetermined solvent (orientation film varnish) is applied onto a substrate according to a spin coating method, then heated under a predetermined condition thereon to promote imidization through solvent vaporization, thereby forming a thin film on the substrate.

Subsequently, the formed thin film is processed for alignment in various methods. For example, the film is rubbed for physical friction with a soft blanket, or in case where the orientation film material has a photoreactive group, the film is irradiated with UV ray (for a photo-alignment process), whereby the polyimide thin film is processed for alignment. The treatment makes the film function as an orientation film for liquid crystal display devices (for the liquid crystal alignment capability).

Specifically, the orientation film for the liquid crystal display device of the invention is preferably given the liquid crystal alignment capability through a photo-alignment process.

Preferably, the orientation film has a photoreactive group, and is processed to have the liquid crystal alignment capability through irradiation with UV rays.

The photoreactive group is a functional group that has the property of being readily decomposed through photoirradiation to thereby form a covalent bond with a nearest molecule. Specific examples of the photoreactive group include an acrylic group, a methacrylic group, a maleimide group, an oxetane group, a vinyl ether group.

In case where the compound to form the orientation film has a cyclobutane structure, it forms a maleimide group through irradiation with UV rays. Accordingly, the compound to form the orientation film may have a cyclobutane structure and may be given liquid crystal alignment capability through a photo-alignment process.

The orientation film in one embodiment of the liquid crystal display device of the invention has a photoreactive group. In case where the photoreactive group is entirely reacted through irradiation of the orientation film with UV rays, the photoreactive group may not remain in the orientation film.

The above-mentioned photoreactive groups are only some examples of the group, and the photoreactive group should not be limited to these functional groups.

The orientation film in the liquid crystal display device of the invention may be given the liquid crystal alignment capability through rubbing alignment treatment.

The region of the orientation film given the liquid crystal alignment capability as above is preferably within a range of up to 20 nm from the surface of the orientation film. When the orientation film is processed to have the liquid crystal alignment capability even in the region deeper than 20 nm, there may occur a problem in that the mechanical strength of the orientation film may lower as a whole.

For example, the region of the orientation film given the liquid crystal alignment capability may be within a range of up to 20 nm from the surface of the orientation film, and the region of the film deeper than 20 nm may not be given the liquid crystal alignment capability.

The reduction in the mechanical strength of the orientation film itself may bring about various problems in long-term deriving of the liquid crystal display device comprising the film, in that the initial alignment direction of the orientation film surface is gradually lost, therefore resulting in liquid crystal alignment capability depression to cause degradation of display characteristics. For preventing the display characteristics degradation, the orientation film may be chemically crosslinked after given the liquid crystal alignment capability, whereby the mechanical strength of the film may be effectively increased to prevent the display characteristics degradation.

Further, after the orientation film is given the liquid crystal alignment capability, preferably, the orientation film is further processed for crosslinking the compounds therein to each other.

Specifically, it is desirable that the orientation film given the liquid crystal alignment capability has a crosslinking group, and is processed for crosslinking treatment. After the orientation film is given the liquid crystal alignment capability, crosslinking the film is effective for increasing the hardness of the orientation film.

For example, in case where the orientation film is given the liquid crystal alignment capability through irradiation with UV rays as mentioned in the above and when X in the chemical formula (1) has a cyclobutane group, the cyclobutane group may be cleaved through UV irradiation to form a maleimide group. The compounds to form the orientation film shall be crosslinked via the maleimide group.

For example, when the compound represented by the chemical formula (1) contains a thermoreactive group such as an epoxy group or the like, the compounds to form the orientation film shall be crosslinked via the epoxy group.

Further, the liquid crystal display device of the invention has still another characteristic feature in that the coating ratio with the orientation film in the display region thereof is at least 50%.

Specifically, in case where the coating ratio with the orientation film in the liquid crystal display device relative to the display region of the device is at least 50%, the display image could be effectively protected from burn-in.

More preferably, the coating ratio with the orientation film relative to the display region is at least 60%, even more preferably, the coating ratio with the orientation film relative to the display region is at least 75%.

The invention is described in detail with reference to Examples given below, however, the technical scope of the invention should not be limited by the following Examples.

### Example 1

First, various types of polyimides having a chemical structure represented by the following chemical formula (1) were produced for orientation films.

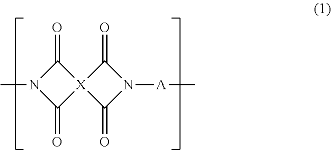

X in the chemical structure represented by the above-mentioned chemical formula (1) includes the following two types of (X-1) and (X-2):

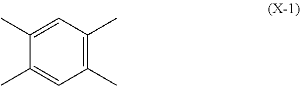

In polyimide production, when pyromellitic acid is used as the starting material, then a polyimide having the above-mentioned chemical structure (X-1) can be produced.

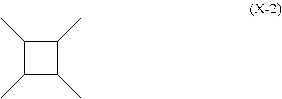

In polyimide production, when i acid is used as the starting material, then a polyimide having the above-mentioned chemical structure (X-2) can be produced. A in the chemical structure represented by the above-mentioned chemical formula (1) includes the following five types of (A-1) to (A-5):

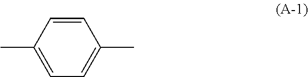

In polyimide production, when 1,4-phenylenediamine is used as the starting material, then a polyimide having the above-mentioned chemical structure (A-1) can be produced.

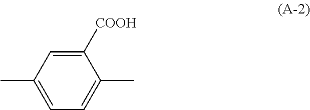

In polyimide production, when 2,5-diaminophenylcarboxylic acid is used as the starting material, then a polyimide having the above-mentioned chemical structure (A-2) can be produced.

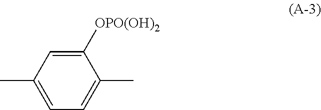

In polyimide production, when 2,5-diaminophenylphosphoric acid is used as the starting material, then a polyimide having the above-mentioned chemical structure (A-3) can be produced.

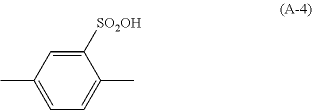

In polyimide production, when 2,5-diaminophenylsulfonic acid is used as the starting material, then a polyimide having the above-mentioned chemical structure (A-4) can be produced.

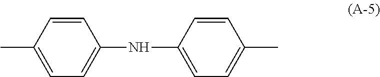

In polyimide production, when 4,4′-diaminophenylamine is used as the starting material, then a polyimide having the above-mentioned chemical structure (A-5) can be produced.

Precursor polyamide acids before imidization were produced according to predetermined production methods for ten types of polyimides, for which the chemical structures of the above-mentioned X and A were combined.

The base polyimides are P-1-1 (polymer produced to have the above-mentioned chemical formulae (X-1) and (A-1) in a ratio of 1/1 (by mol)), and P-1-2 (polymer produced to have the above-mentioned chemical formulae (X-2) and (A-1) in a ratio of 1/1 (by mol)).

The other polymers were produced from the component of the above-mentioned compound (X-1) or (X-2) and the component selected from the above-mentioned compounds (A-1) to (A-5) (hereinafter this is referred to as the component A) in a ratio of 1/1 (by mol).

Various polymers were produced in which the molar ratio of the component A (diamine skeleton-having compound) was compound (A-1)/compound (A-n, n=2 to 5)=3/1. The molecular weight of the obtained polymer was measured through GPC, from which polystyrene standards number-average molecular weight thereof was determined.

The obtained polyamide acid was dissolved in a mixed solvent of N-methyl-2-pyrrolidone (NMP), γ-butyrolactone (GBL) and butyl cellosolve (BC) to prepare an orientation film varnish.

Next, samples for evaluation of the physical properties of the orientation film itself were produced according to the following process. As a substrate, used was a synthetic quartz substrate (for evaluation of optical properties) or an ITO transparent electrode-having glass substrate (for evaluation of electrical properties). Before the test, the substrate was washed and irradiated with UV/O₃. The above orientation film varnish was applied to it in a mode of spin coating, then immediately predried at 80° C. for 1 minute, and thereafter baked for imidization at 230° C. for 1 hour.

In this, the varnish concentration and the spin-coating rotation frequency were so selected that the film thickness after the baking for imidization could be 200 nm or so.

Next, the polymer with X=X1 was processed for rubbing alignment treatment (with a rayon rubbing cloth, at a rotation frequency of 1500 rpm and at a feeding speed of 32.5 mm/min with incisions of 0.4 mm) in air at room temperature. The polymer with X=X2 was processed for photo-alignment process (through irradiation with polarized UV rays vertically to the substrate surface, that is, selective irradiation with light having a wavelength of from 230 to 300 nm from a low-pressure mercury light source, at a substrate temperature during irradiation of 200° C. and at a radiation energy of 2 J). Further, on the orientation film for evaluation of electrical properties, a Cr—Al alloy was patterning-sputtered via a metal mask put thereon.

The optical properties of the orientation film were evaluated according to the process mentioned below. The produced sample for evaluation of optical properties was analyzed with a UV-visible spectrophotometer to measure the transmittance of the orientation film within a wavelength range of from 200 to 750 nm.

The polyimide orientation film had a main absorption peak in the UV region, and its absorption end tailed into the visible region, but the film did not have any detectable absorption peak in the visible region. Accordingly, the mean value within the wavelength range of from 380 to 400 nm was taken as the transmittance (%) of the orientation film.

The electrical properties of the orientation film were evaluated according to the process mentioned below. Using a picoampere meter, the produced sample for evaluation of electrical properties was analyzed for the current running therethrough within a range of from 0 to 10 V; and from the voltage-current relation mainly in a stable region of 1 V or more and the thickness thereof, the resistivity of the sample was determined.

The physical data of the orientation film are collectively shown in Table 1. The samples in which the part of the chemical structure A has a polar group have a lower resistivity (specific resistance), and are expected to accept easy current running therethrough.

TABLE 1

| | | | | | Specific |
|---|---|---|---|---|---|
| | | | Molecular | Transmittance | Resistance |
| Polymer | X | A | Weight | (%) | (Ωcm) |
| P-1-1 | X-1 | A-1 | 15,000 | 87 | 3 × 10⁺¹⁴ |
| P-1-2 | X-2 | A-1 | 15,000 | 90 | 2 × 10⁺¹⁴ |
| P-1-3 | X-1 | A-2 | 14,000 | 84 | 1 × 10⁺¹⁴ |
| P-1-4 | X-2 | A-2 | 14,500 | 88 | 7 × 10⁺¹³ |
| P-1-5 | X-1 | A-3 | 12,000 | 84 | 8 × 10⁺¹³ |
| P-1-6 | X-2 | A-3 | 11,500 | 88 | 6 × 10⁺¹³ |
| P-1-7 | X-1 | A-4 | 13,000 | 85 | 2 × 10⁺¹³ |
| P-1-8 | X-2 | A-4 | 13,500 | 89 | 6 × 10⁺¹² |
| P-1-9 | X-1 | A-5 | 13,500 | 75 | 1 × 10⁺¹⁴ |
| P-1-10 | X-2 | A-5 | 14,000 | 78 | 6 × 10⁺¹³ |

Of the above, those in which the chemical structure A has an anionic carboxylic acid, phosphoric acid or sulfonic acid are compared with each other; and the samples in which the polarity of the substituent is higher have a lower resistance. Of the samples in which the chemical structure A has a cationic diphenylamine, the resistance could be reduced in some degree, but the transmittance thereof also reduced to the 70% level.

Next, using the orientation film of the invention, liquid crystal display devices were produced and evaluated for the image quality, according to the process mentioned below.

First, liquid crystal display devices were produced in an ordinary process, in which, however, the orientation film material of the invention was used in place of the ordinary orientation film material.

For example, in a typical production method for IPS-mode liquid crystal display devices, the active matrix substrate 6 and the counter substrate 7 that had been previously processed for alignment were combined with a liquid crystal material sealed up therebetween, and stuck together to construct a cell; and in this step, the initial alignment direction of the orientation film 606 for the active matrix substrate 6 and the initial alignment direction of the orientation film 705 for the counter substrate 7 were made to be substantially parallel to each other.

The liquid crystal material to be sealed up in the cell is, for example, a nematic liquid crystal composition A having a positive dielectric anisotropy Δ∈ of 10.2 (1 kHz, 20° C.), a refractivity anisotropy Δn of 0.075 (wavelength 590 nm, 20° C.), a twisted elastic constant K₂ of 7.0 pN, a nematic-to-isotropic transition temperature T (N-I) of about 76° C. and a resistivity of 1×10⁺¹³ Ωcm.

In this, the active matrix substrate 6 and the counter substrate 7 were so stuck together that the thickness of the liquid crystal layer 11a (cell gap) could be substantially the same as the height of the columnar spacer 10, for example, 4.2 μm. The retardation (Δn·d) of the liquid crystal panel 1 thus produced under the condition as above was about 0.31 μm.

It is desirable that Δn·d satisfies a range of 0.2 μm≦Δn·d≦0.5 μm, and when Δn·d exceeds this range, there arises such a problem that white display is colored. After the liquid crystal material was sealed up between the active matrix substrate 6 and the counter substrate 7 stuck together, for example, the unnecessary parts (margins) around the outer periphery of the glass substrates 601 and 701 were cut off, and the polarizers 9a and 9b were stuck thereto.

When the polarizers 9a and 9b were so stuck that the polarization transmission axis of one polarizer could be substantially parallel to the initial alignment direction of the orientation film 606 for the active matrix substrate 6 and that of the orientation film 705 for the counter substrate 7, and the polarization transmission axis of the other polarizer could be perpendicular thereto.

Subsequently, a first drive circuit 2, a second drive circuit 3, a control circuit 4 and a backlight 5 were connected thereto for module assembly, thereby producing a liquid crystal display device having the liquid crystal display panel 1 of Example 1.

The liquid crystal display panel 1 of Example 1 has a normally-closed characteristic in that it produces a dark display (low-brightness display) when the potential difference between the pixel electrode PX and the common electrode CT is small but produces a bright display (high-brightness display) when the potential difference between the pixel electrode PX and the common electrode CT is large. The liquid crystal display devices of other types are produced in an ordinary manner for the individual drive modes, therefore securing both dark display and bright display.

These liquid crystal display devices were tested for burn-in according to the process mentioned below. Briefly, the liquid crystal display device was continuously driven to exhibit a black/white window pattern for a predetermined period of time, then switched to a display voltage for gray-level halftone display on the entire area of the panel, whereupon the time before the disappearance of the window pattern (burn-in, this may be referred to as the residual image) was reckoned.

In case where no residual charges form in the surface of the orientation film and when the device could keep a good orientation film surface condition, then the entire panel could immediately exhibit a gray-level display; however, owing to the residual charges formed in the bright display area, the display voltage effectively acting on the area would differ from that on the dark display area to which voltage application is the first in this time, therefore presenting a slight brightness difference (the residual image).

The time for which the display state is kept as such until the residual charges disappear and the entire panel surface could exhibit a uniform display is reckoned as a burn-in time. The three selected continuous drive times were 1, 10 or 100 hours; and the burn-in time after the continuous display was represented by t₁, t₁₀ or t₁₀₀, respectively.

Table 2A and Table 2B each show the burn-in time with the IPS-mode liquid crystal display device of FIG. 2 that comprises the orientation film shown in Table 1. All the polymers tended to prolong the burn-in time when the continuous drive time was longer. Of the above samples, those where the orientation film was processed (for rubbing alignment treatment) as in Table 2A tended to have a shorter the residual image time when the resistivity of the orientation film of Table 1 therein was smaller.

TABLE 2A

| Polymer | t₁ (sec) | t₁₀ (min) | t₁₀₀ (min) |
|---|---|---|---|
| P-1-1 | 15 | 8 | 20 |
| P-1-3 | 13 | 7 | 18 |
| P-1-5 | 10 | 6 | 15 |
| P-1-7 | 7 | 5 | 10 |
| P-1-9 | 12 | 7 | 17 |

The samples with the orientation film (processed for photo-alignment process) as in Table 2B also had the same tendency, but overall, the burn-in time in those samples was longer than that of the samples of Table 2A.

TABLE 2B

| Polymer | t₁ (sec) | t₁₀ (min) | t₁₀₀ (min) |
|---|---|---|---|
| P-1-2 | 27 | 11 | 30 |
| P-1-4 | 22 | 10 | 29 |
| P-1-6 | 18 | 9 | 25 |
| P-1-8 | 13 | 6 | 20 |
| P-1-10 | 21 | 10 | 28 |

As in the above, it is known that the orientation film containing the polyimide having a chemical structure of the chemical formula (1) in which the chemical structure A has an anionic organic acid except organic acids in the narrow sense is effective for shortening the residual image time in the liquid crystal display device, not detracting from the transparency of the display panel.

### Example 2

Next, using the orientation film material shown in Example 1, an FFS-mode liquid crystal display device shown in FIG. 3 was produced and tested for the burn-in time thereof. The results are shown below.

The FFS-mode display structure is similar to the structure of an IPS-mode device; and in the former, a pixel electrode PX and a common electrode CT are formed only on one side of the upper and lower substrates, and the liquid crystal molecules rotates in the plane depending on the presence or absence of the electric field given between them. Accordingly, the initial alignment state in the absence of an electric field in the FFS-mode is the same as that in the IPS-mode; and in the former, the alignment direction to be given to the orientation film 606 (and 705) may also the same as that in the latter, and the liquid crystal to be used in the former may be one having a positive dielectric anisotropy Δ∈.

TABLE 3A

| Polymer | t₁ (sec) | t₁₀ (min) | t₁₀₀ (min) |
|---|---|---|---|
| P-1-1 | 16 | 9 | 22 |
| P-1-3 | 15 | 8 | 19 |
| P-1-5 | 13 | 7 | 16 |
| P-1-7 | 9 | 6 | 11 |
| P-1-9 | 14 | 8 | 18 |

TABLE 3B

| Polymer | t₁ (sec) | t₁₀ (min) | t₁₀₀ (min) |
|---|---|---|---|
| P-1-2 | 29 | 13 | 33 |
| P-1-4 | 25 | 12 | 31 |
| P-1-6 | 20 | 10 | 28 |
| P-1-8 | 15 | 8 | 23 |
| P-1-10 | 23 | 12 | 30 |

Table 3A and Table 3B show collectively the burn-in time in the FFS-mode liquid crystal display devices where the same orientation film material as in Example 1 was used. Like in Example 1, all the samples where the orientation film was rubbed (Table 3A) and the samples where the orientation film was photoaligned (Table 3B) tended to have a shorter burn-in time when the resistivity of the orientation film therein was smaller.

As in the above, it is known that the orientation film containing the polyimide having a chemical structure of the chemical formula (1) in which the chemical structure A has an anionic organic acid except organic acids in the narrow sense is effective for shortening the residual image time in the liquid crystal display device, not detracting from the transparency of the display panel.

### Example 3

Next, using the orientation film material shown in Example 1, a VA-mode liquid crystal display device shown in FIG. 4 was produced and tested for the burn-in time thereof. The results are shown below.

The VA-mode display structure differs from the structure of an IPS-mode or FFS-mode device. In this, a pixel electrode PX and a common electrode CT are formed on both the upper and lower substrates, and a VA-mode liquid crystal material having a negative dielectric anisotropy Δ∈ is used, and must be so aligned that in the initial alignment state in the absence of an electric field, the liquid crystal molecules could be substantially perpendicular to the substrate.

Accordingly, ordinary rubbing would be difficult to employ here. In this, the polymer P-1-2, P-1-4, P-1-6, P-1-8 or P-1-10 was used as an orientation film material, and was photoaligned through irradiation with polarized UV ray from an oblique direction, with reference to Technical Reference 2.
Technical Reference 2: P. Gass, H. Stevenson, R. Bay, H. Walton, N. Smith, S. Terashita and M. Tillin. Patterning Photoalignment for Vertically Aligned LCD, Sharp's Technical Report No. 85 (2003), pp. 24-29

TABLE 4

| Polymer | t₁ (sec) | t₁₀ (min) | t₁₀₀ (min) |
|---|---|---|---|
| P-1-2 | 55 | 21 | 48 |
| P-1-4 | 50 | 20 | 44 |
| P-1-6 | 46 | 16 | 40 |
| P-1-8 | 40 | 12 | 37 |
| P-1-10 | 52 | 19 | 42 |

Table 4 shows collectively the burn-in time in the tested samples. When compared with the data in Example 1, the burn-in time in this Example is longer as a whole; however, both in the case of rubbing alignment treatment (Table 3A) and in the case of photo-alignment process (Table 3B), the burn-in time in the samples tended to be shorter when the resistivity of the orientation film was smaller.

As in the above, it is known that the orientation film containing the polyimide having a chemical structure of the chemical formula (1) in which the chemical structure A has an anionic organic acid except organic acids in the narrow sense is effective for shortening the residual image time in the liquid crystal display device, not detracting from the transparency of the display panel.

### Example 4

Next, using an orientation film material in which the chemical structure A has an anionic organic ester group except organic acids in the narrow sense, samples were produced and tested in the same manner as in Example 1, and the results are shown below.

Specifically, in this Example, liquid crystal display devices were produced, in which the divalent organic group A in the chemical formula (1) to form the orientation film is an acid ester group of an anionic organic acid except organic acids in the narrow sense.

The orientation film material used here is represented by the chemical formula (1) had the chemical structure X of (X-1) or (X-2) like in Example 1 but had an acid ester of the following (A-2E) to (A-4E) as the chemical structure A.

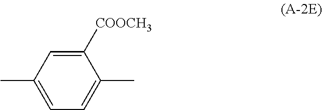

Chemical formula (A-2E) corresponds to the above-mentioned chemical formula (A-2) where the carboxyl group has formed an ester with methanol, or that is, this is an acetate ester of (A-2).

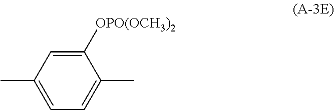

Chemical formula (A-3E) corresponds to the above-mentioned chemical formula (A-3) where the phosphoric acid group has formed an ester with methanol, or that is, this is a phosphate ester of (A-3).

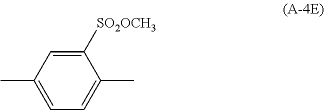

Chemical formula (A-4E) corresponds to the above-mentioned chemical formula (A-4) where the sulfo group has formed an ester with methanol, or that is, this is a sulfate ester of (A-4).

TABLE 5

| | | | | | Specific |
|---|---|---|---|---|---|
| | | | Molecular | Transmittance | Resistance |
| Polymer | X | A | Weight | (%) | (Ωcm) |
| P-1-1 | X-1 | A-1 | 15,000 | 87 | 3 × 10⁺¹⁴ |
| P-1-2 | X-2 | A-1 | 15,000 | 90 | 2 × 10⁺¹⁴ |
| P-4-3 | X-1 | A-2E | 16,000 | 86 | 3 × 10⁺¹⁴ |
| P-4-4 | X-2 | A-2E | 15,500 | 88 | 2 × 10⁺¹⁴ |
| P-4-5 | X-1 | A-3E | 13,000 | 85 | 2 × 10⁺¹⁴ |
| P-4-6 | X-2 | A-3E | 12,500 | 89 | 1 × 10⁺¹⁴ |
| P-4-7 | X-1 | A-4E | 14,000 | 86 | 8 × 10⁺¹³ |
| P-4-8 | X-2 | A-4E | 14,500 | 87 | 7 × 10⁺¹³ |

Table 5 shows collectively the main physical properties of those orientation film materials. For comparison, the data of the polymers P-1-1 and P-1-2 are also shown therein. These are all polymers having a molecular weight falling from 12,000 to 16,000 and having a transmittance of at least 80%.

The resistivity (the specific resistance value) of these polymers does not almost differ from that of the polymers P-1-1 and P-1-2, but the resistivity of the polymers P-4-7 and P-4-8, in which (A-4E) that is considered to have a largest polarity is used as the component A, is somewhat lower than that of the others.

TABLE 6A

| Polymer | t₁ (sec) | t₁₀ (min) | t₁₀₀ (min) |
|---|---|---|---|
| P-1-1 | 15 | 8 | 20 |
| P-4-3 | 15 | 8 | 21 |
| P-4-5 | 15 | 8 | 20 |
| P-4-7 | 12 | 6 | 18 |

TABLE 6B

| Polymer | t₁ (sec) | t₁₀ (min) | t₁₀₀ (min) |
|---|---|---|---|
| P-1-2 | 27 | 11 | 30 |
| P-4-4 | 22 | 10 | 29 |
| P-4-6 | 21 | 10 | 28 |
| P-4-8 | 13 | 6 | 20 |

Table 6A and Table 6B show the burn-in time in the IPS-mode liquid crystal display devices of FIG. 2 where the orientation film shown in Table 5 was used. Like in Example 1, all the samples tended to take a longer burn-in time when the continuous drive time was longer.

However, when the samples were compared with each other in point of the type of the orientation film material used therein, it is known that the samples in this Example did not almost differ from those with the comparative polymer P-1-1 or P-1-2 in point of the burn-in time; and only the samples with the polymer P-4-7 or P-4-8 where (A-4E) was used as the component A took a somewhat shorter burn-in time.

As in the above, it is known that the orientation film containing the polyimide having a chemical structure of the chemical formula (1) in which the chemical structure A has an anionic organic acid ester group except organic acids in the narrow sense is effective for shortening the residual image time in the liquid crystal display device especially when the chemical structure A has a relatively high polarity, not detracting from the transparency of the display panel.

### Example 5

This is to demonstrate the effect of the orientation film material in which an anionic organic acid skeleton except organic acids in the narrow sense bonds to the chemical structure A in a mode of non-conjugated bonding thereto. Samples were produced and tested in the same manner as in Example 1, and the results are shown below.

Specifically, in this Example, the chemical structure of any of an anionic organic acid except organic acids in the narrow sense or an acid ester group of an anionic organic acid except organic acids in the narrow sense is in direct chemical bond to a non-conjugated organic group in the orientation film in the liquid crystal display device.

In place of the chemical structure (A-4) in Example 1 in which a sulfonic acid group directly bonds to a phenyl ring, a chemical structure where a sulfonic acid group bonds to a phenyl ring via a methylene chain as shown below was used here. X is the same as in Example 1, or that is, X is selected from two, X=(X-1) or (X-2). The others were the same as in Example 1.

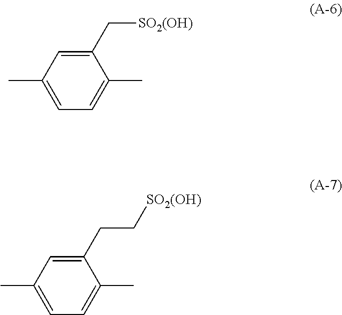

TABLE 7

| | | | | | Specific |
|---|---|---|---|---|---|
| | | | Molecular | Transmittance | Resistance |
| Polymer | X | A | Weight | (%) | (Ωcm) |
| P-1-1 | X-1 | A-1 | 15,000 | 87 | 3 × 10⁺¹⁴ |
| P-1-2 | X-2 | A-1 | 15,000 | 90 | 2 × 10⁺¹⁴ |
| P-5-1 | X-1 | A-6 | 15,000 | 88 | 1 × 10⁺¹³ |
| P-5-2 | X-2 | A-6 | 15,500 | 90 | 7 × 10⁺¹² |
| P-5-3 | X-1 | A-7 | 14,500 | 89 | 9 × 10⁺¹² |
| P-5-4 | X-2 | A-7 | 14,000 | 91 | 6 × 10⁺¹² |
| P-1-7 | X-1 | A-4 | 13,000 | 85 | 2 × 10⁺¹³ |
| P-1-8 | X-2 | A-4 | 13,500 | 89 | 6 × 10⁺¹² |

Table 7 shows the physical data of the orientation films of the obtained polymers P-5-1, P-5-2, P-5-3 and P-5-4. For comparison, the data of the films of polymers P-1-1 and P-1-2 not having a sulfonic acid group, and those of the films of polymers P-1-7 and P-1-8 where sulfonic acid directly bonds to the phenyl ring are shown therein.

The methylene chain existing between the sulfonic acid residue and the phenyl ring cut the conjugated structure, and as a result, the transparency of the thin films in this Example increased to the same level as that of the films of the polymer of P-1-7 or P-1-8.

On the other hand, the resistivity (the specific resistance value) of the thin films in this Example was kept low, not almost differing from that of the thin films of the polymer of P-1-7 or P-1-8.

TABLE 8A

| Polymer | t₁ (sec) | t₁₀ (min) | t₁₀₀ (min) |
|---|---|---|---|
| P-1-1 | 15 | 8 | 20 |
| P-5-1 | 8 | 5 | 10 |
| P-5-3 | 7 | 5 | 10 |
| P-1-7 | 7 | 5 | 10 |

TABLE 8B

| Polymer | t₁ (sec) | t₁₀ (min) | t₁₀₀ (min) |
|---|---|---|---|
| P-1-2 | 27 | 11 | 30 |
| P-5-2 | 14 | 6 | 20 |
| P-5-4 | 13 | 6 | 19 |
| P-1-8 | 13 | 6 | 20 |

Table 8A and Table 8B show the burn-in time in the IPS-mode liquid crystal display devices where the orientation films were used like in Example 1. (The polymers in Table 8A formed orientation films through rubbing alignment treatment, and the polymers in Table 8B formed orientation films through photo-alignment process.) It is known that the polymers in this Example provided a short burning time on the same level as that with the polymers P-1-7 and P-1-8.

As in the above, it is known that even the orientation film containing the polyimide having a chemical structure of the chemical formula (1) in which an anionic organic acid except organic acids in the narrow sense bonds to the chemical structure A via a non-conjugated bond is effective for shortening the residual image time in the liquid crystal display device, not detracting from the transparency of the display panel.

### Example 6

This is to demonstrate the effect of the orientation film material in which the ratio of the anionic organic acid skeleton except organic acids in the narrow sense differs in the chemical structure A, and the results are shown below.

In producing the polymers in Example 1, the molar ratio of the component A (diamine skeleton-having compound) was compound (A-1)/compound (A-n, n=2 to 5)=3/1, or that is, (A-n)/{(A-1)+(A-n)}=25 mol %.

In this, the sulfonic acid group (n=4) that is a substituent having a highest polarity was specifically noted; and the ratio of (A-4)/{(A-1)+(A-4)} was increased to 50, 75 and 100 mol %. The samples were analyzed and evaluated for the properties thereof in the same manner as in Example 1.

TABLE 9

| | | | | | | Specific |
|---|---|---|---|---|---|---|
| | | | Ratio | Molecular | Transmittance | Resistance |
| Polymer | X | A | (%) | Weight | (%) | (Ωcm) |
| P-1-1 | X-1 | A-1 | 0 | 15,000 | 87 | 3 × 10⁺¹⁴ |
| P-1-2 | X-2 | A-1 | 0 | 15,000 | 90 | 2 × 10⁺¹⁴ |
| P-1-7 | X-1 | A-4 | 25 | 13,000 | 85 | 2 × 10⁺¹³ |
| P-1-8 | X-2 | A-4 | 25 | 13,500 | 89 | 6 × 10⁺¹² |
| P-6-1 | X-1 | A-4 | 50 | 12,000 | 80 | 3 × 10⁺¹² |
| P-6-2 | X-2 | A-4 | 50 | 11,500 | 83 | 5 × 10⁺¹¹ |
| P-6-3 | X-1 | A-4 | 75 | 13,000 | 75 | 2 × 10⁺¹¹ |
| P-6-4 | X-2 | A-4 | 75 | 13,500 | 79 | 7 × 10⁺¹⁰ |
| P-6-5 | X-1 | A-4 | 100 | 13,500 | 70 | 4 × 10⁺¹⁰ |
| P-6-6 | X-2 | A-4 | 100 | 14,000 | 73 | 1 × 10⁺¹⁰ |

Table 9 collectively shows the physical properties of the thin films of the obtained polymers. With the increase in the ratio of the sulfonic acid group in the polymer, the resistivity (the specific resistance value) of the thin film decreased and the transparency thereof also decreased.

TABLE 10A

| Polymer | t₁ (sec) | t₁₀ (min) | t₁₀₀ (min) |
|---|---|---|---|
| P-1-1 | 15 | 8 | 20 |
| P-1-7 | 7 | 5 | 10 |
| P-6-1 | 3 | 2 | 6 |
| P-6-3 | 8 | 6 | 9 |
| P-6-5 | *** | *** | *** |

TABLE 10B

| Polymer | t₁ (sec) | t₁₀ (min) | t₁₀₀ (min) |
|---|---|---|---|
| P-1-2 | 27 | 11 | 30 |
| P-1-8 | 13 | 6 | 20 |
| P-6-2 | 10 | 3 | 14 |
| P-6-4 | 14 | 6 | 21 |
| P-6-6 | *** | *** | *** |

Table 10A and Table 10B show the burn-in time in the IPS-mode liquid crystal display devices where the orientation film was formed of the polymer prepared herein. When the molar ratio of the compound (A-4) increased from 25% up to 50%, then the burn-in time was shorter, but when increased further up to 75%, then the burn-in time rather increased.

When the ratio was 100%, then the polymer polarity was too high and the orientation film could not be well formed by coating. Accordingly, stable continuous image display was impossible and the burn-in time was difficult to determine.

As in the above, it is known that, in the orientation film containing the polyimide having a chemical structure of the chemical formula (1) in which an anionic organic acid except organic acids in the narrow sense bonds to the chemical structure A, when the ratio of the organic acid was varied, then the transparency and the resistivity of the film changed, however, it could not indiscriminately be said that the orientation film having a smaller resistivity could shorten the burn-in time, and it is known that the transparency of the orientation film of the type is often low.

### Example 7

This is to demonstrate the effect of the orientation film formed of a mixture of a polyimide having the chemical structure of the chemical formula (1) where an anionic organic acid except organic acids in the narrow sense bonds to the chemical structure A, and a polymer different from the polyimide. The results are shown below.

Specifically in this Example, the orientation film in a liquid crystal display device is formed of a mixture of a polyimide containing the chemical structure D and a polymer not containing the chemical structure D.

As the polyimide in which an anionic organic acid except organic acids in the narrow sense bonds to the chemical structure A, selected were the polymers P-6-1 and P-6-2 in Example 6; and as the other polymer, selected were the polymers P-1-1 and P-1-2 in Example 1. As the blend for the orientation film to be processed by rubbing alignment treatment, selected were P-1-1 and P-6-1; and as the blend for the orientation film to be processed by photo-alignment process, selected were P-1-2 and P-6-2. Polymer mixtures were prepared in which the molar ratio of P-6-1 (or P-6-2) was changed to 0% (P-1-1, P-1-2), 25% (P-7-1, P-7-2), 50% (P-7-3, P-7-4), 75% (P-7-5, P-7-6) or 100% (P-6-1, P-6-2); the polymer mixtures were formed into orientation film samples in the same manner as in Example 1.

TABLE 11

| | | | Specific |
|---|---|---|---|
| | Ratio | Transmittance | Resistance |
| Polymer | (%) | (%) | (Ωcm) |
| P-1-1 | 0 | 87 | 3 × 10⁺¹⁴ |
| P-1-2 | 0 | 90 | 2 × 10⁺¹⁴ |
| P-7-1 | 25 | 85 | 8 × 10⁺¹³ |
| P-7-2 | 25 | 88 | 2 × 10⁺¹³ |
| P-7-3 | 50 | 83 | 3 × 10⁺¹³ |
| P-7-4 | 50 | 86 | 6 × 10⁺¹² |
| P-7-5 | 75 | 81 | 9 × 10⁺¹² |
| P-7-6 | 75 | 84 | 1 × 10⁺¹² |
| P-6-1 | 100 | 80 | 3 × 10⁺¹² |
| P-6-2 | 100 | 83 | 5 × 10⁺¹¹ |

Table 11 collectively shows the physical properties of the obtained thin films of orientation films. From this, it is known that the transmittance and the resistivity (the specific resistance value) of the polymer blend orientation films are both on the intermediate level of the data of the corresponding single polymer orientation films.

TABLE 12A

| Polymer | t₁ (sec) | t₁₀ (min) | t₁₀₀ (min) |
|---|---|---|---|
| P-1-1 | 15 | 8 | 20 |
| P-7-1 | 10 | 6 | 14 |
| P-7-3 | 6 | 5 | 10 |
| P-7-5 | 4 | 3 | 8 |
| P-6-1 | 3 | 2 | 6 |

TABLE 12B

| Polymer | t₁ (sec) | t₁₀ (min) | t₁₀₀ (min) |
|---|---|---|---|
| P-1-2 | 27 | 11 | 30 |
| P-7-2 | 21 | 9 | 22 |
| P-7-4 | 18 | 7 | 19 |
| P-7-6 | 13 | 5 | 16 |
| P-6-2 | 10 | 3 | 14 |

Table 12A and Table 12B show the burn-in time in the IPS-mode liquid crystal display devices where the orientation film was formed of the polymer prepared herein. The burn-in time in the devices where the blend polymer was used in producing the orientation film is on the intermediate level of the data of the device comprising the corresponding single polymer orientation film.

The sulfur atom S in the sulfonic acid in the film was specifically noted; and the film was analyzed for the composition distribution therein according to sputtering SIMS (secondary ionization mass spectroscopy) from the surface side of the film. As a result, it is known that, in the films P-6-1 and P-6-2, the chemical structure concentration was uniform, as in FIG. 5B, but in the films P-7-1, P-7-2, P-7-3, P-7-4, P-7-5 and P-7-6, the sulfur element S distributed at a lower concentration nearer to the film surface, as in FIG. 5C.

As in the above, it is known that, when a mixture of a polyimide having the chemical structure of the chemical formula (1) in which an anionic organic acid except organic acids in the narrow sense bonds to the chemical structure A, and a polymer except the polyimide is used in producing the orientation film, it can reduce the burn-in time in display devices not detracting from the transparency of the film.

### Example 8

This is to demonstrate the effect of the orientation film formed of a mixture of a polyimide having the chemical structure of the chemical formula (1) where an anionic organic acid except organic acids in the narrow sense bonds to the chemical structure A, and a polymer except the polyimide and differing from the polymer in Example 7. The results are shown below.

Specifically in this Example, the orientation film in a liquid crystal display device is formed of a mixture of a polyimide containing the chemical structure D and a polymer not containing the chemical structure D.

In this, X is the same as above, or that is, X=(X-1) or (X-2), and A is the following structure (A-8):

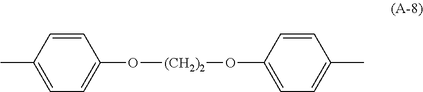

Herein prepared were a polymer P-8-1 where X=X1 and A=A8 and a polymer P-8-2 where X=X2 and A=A8. The polymers each had a molecular weight of 21,000 and 20,000, respectively.

TABLE 13

| | | | Specific |
|---|---|---|---|
| | Ratio | Transmittance | Resistance |
| Polymer | (%) | (%) | (Ωcm) |
| P-8-1 | 0 | 89 | 5 × 10⁺¹⁴ |
| P-8-2 | 0 | 92 | 4 × 10⁺¹⁴ |
| P-8-3 | 25 | 87 | 1 × 10⁺¹⁴ |
| P-8-4 | 25 | 90 | 7 × 10⁺¹³ |
| P-8-5 | 50 | 84 | 6 × 10⁺¹³ |
| P-8-6 | 50 | 88 | 2 × 10⁺¹³ |
| P-8-7 | 75 | 82 | 1 × 10⁺¹³ |
| P-8-8 | 75 | 85 | 2 × 10⁺¹² |
| P-6-1 | 100 | 80 | 3 × 10⁺¹² |
| P-6-2 | 100 | 83 | 5 × 10⁺¹¹ |

Table 13 collectively shows the physical properties of the obtained thin films of orientation films. From this, it is known that the transmittance and the resistivity (the specific resistance value) of the polymer blend orientation films are both on the intermediate level of the data of the corresponding single polymer orientation films.

However, as compared with the data in Example 7, the data in this Example fluctuate more since the polymer P-8-1 (and P-8-2) has a higher resistance and a higher transmittance in some degree than the polymer P-1-1 (and P-1-2).

TABLE 14A

| Polymer | t₁ (sec) | t₁₀ (min) | t₁₀₀ (min) |
|---|---|---|---|
| P-8-1 | 15 | 8 | 20 |
| P-8-3 | 6 | 3 | 9 |
| P-8-5 | 1 | 0.5 | 2 |
| P-8-7 | 2 | 1 | 3 |
| P-6-1 | 3 | 2 | 6 |

TABLE 14B

| Polymer | t₁ (sec) | t₁₀ (min) | t₁₀₀ (min) |
|---|---|---|---|
| P-8-2 | 27 | 11 | 30 |
| P-8-4 | 10 | 4 | 17 |
| P-8-6 | 5 | 1 | 9 |
| P-8-8 | 7 | 2 | 11 |
| P-6-2 | 10 | 3 | 14 |

Table 14A and Table 14B show the burn-in time in the IPS-mode liquid crystal display devices where the orientation film was formed of the polymer prepared herein. The burn-in time in the devices where the blend polymer was used in producing the orientation film is on the intermediate level of the data of the device comprising the corresponding single polymer orientation film. As compared with Example 7, some blend polymer films in this Example had improved properties over those of the corresponding single polymer films.

The sulfur atom S in the sulfonic acid in the film was specifically noted; and the film was analyzed for the composition distribution therein according to sputtering SIMS from the surface side of the film. As a result, it is known that, in the films P-8-3, P-8-4, P-8-5, P-8-6, P-8-7 and P-8-8, the sulfur element S distributed at a lower concentration nearer to the film surface, as in FIG. 5C.

From the above, it is known that, when a mixture of a polyimide having the chemical structure of the chemical formula (1) in which an anionic organic acid except organic acids in the narrow sense bonds to the chemical structure A, and a polymer except the polyimide is used in producing the orientation film, it can reduce the burn-in time in display devices not detracting from the transparency of the film.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A liquid crystal display device, comprising:
a pair of substrates at least one of which is transparent;
a liquid crystal layer arranged between the pair of substrates;
a group of electrodes for applying an electric field to the liquid crystal layer, as formed on at least one substrate of the pair of substrates;
a plurality of active elements connected to the group of electrodes; and
an orientation film arranged on the pair of substrates,
wherein at least one orientation film contains a polyimide having a chemical structure represented by the following chemical formula (1): 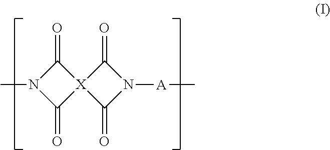
wherein X represents a tetravalent organic group, and A represent a divalent organic group; A has a chemical structure D of any of an anionic organic acid except organic acids in the narrow sense, or an acid ester group of an anionic organic acid except organic acids in the narrow sense.

2. A liquid crystal display device, comprising:
a pair of substrates, at least one of which is transparent;
a liquid crystal layer arranged between the pair of substrates;
a group of electrodes for applying an electric field to the liquid crystal layer, as formed on at least one substrate of the pair of substrates; and
a plurality of active elements connected to the group of electrodes,
wherein the group of electrodes include common electrodes and pixel electrodes,
an interlayer is formed on the common electrode or the pixel electrode, and
an orientation film is formed on the interlayer, and wherein at least one orientation film contains a polyimide having a chemical structure represented by the following chemical formula (1): 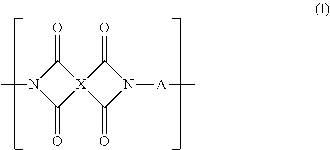
wherein X represents a tetravalent organic group, and A represent a divalent organic group; A has a chemical structure D of any of an anionic organic acid except organic acids in the narrow sense, or an acid ester group of an anionic organic acid except organic acids in the narrow sense.

3. The liquid crystal display device according to claim 1, wherein the chemical structure D in the chemical formula (1) is in direct chemical bond to a non-conjugated organic group.

4. The liquid crystal display device according to claim 1, wherein the orientation film is formed of a mixture of the polyimide containing the chemical structure D in the chemical formula (1) and a different polymer not containing the chemical structure D in the chemical formula (1).

5. The liquid crystal display device according to claim 1, wherein the concentration of the chemical structure D in the chemical formula (1) is distributed to be a lower concentration from the substrate side toward the liquid crystal side in the thickness direction of the orientation film.

6. The liquid crystal display device according to claim 1, wherein the orientation film contains pores having a mean pore size of at most 100 nm inside it, and the orientation film is formed of a material having a specific dielectric constant of at most 2.0.

7. The liquid crystal display device according to claim 1, wherein the chemical structure D in the chemical formula (1) comprises a sulfonic acid group, a sulfonate ester group, a phosphoric acid group, or a phosphoester group.

8. The liquid crystal display device according to claim 1, wherein the orientation film contains a polyimide formed a polyamide acid ester as a precursor.

9. The liquid crystal display device according to claim 1, wherein the orientation film is given the liquid crystal alignment capability through a photo-alignment process.

10. The liquid crystal display device according to claim 1, wherein the orientation film is given the liquid crystal alignment capability through rubbing alignment treatment.

11. The liquid crystal display device according to claim 1, wherein the region of the orientation film given the liquid crystal alignment capability is within a range of up to 20 nm from the surface of the orientation film.

12. The liquid crystal display device according to claim 1, wherein the compounds constituting the orientation film are crosslinked after the film is given the liquid crystal alignment capability.

13. The liquid crystal display device according to claim 1, wherein the coating ratio with the orientation film is at least 50% of the display region.

14. The liquid crystal display device according to claim 2, wherein the thickness of the orientation film is larger than the thickness of the common electrode or the pixel electrode, and the orientation film is a planarizing film for the common electrode or the pixel electrode.
